(19) United States
(12) Patent Application Publication
(10) Pub. No.: US 2013/0124303 A1
(43) Pub. Date: May 16, 2013

(54) Advertising Keyword Generation Using an Image Search

(71) Applicant: Omar Kassem, Cairo (EG)

(72) Inventor: Omar Kassem, Cairo (EG)

(73) Assignee: Google Inc.

(21) Appl. No.: 13/295,892

(22) Filed: Nov. 14, 2011

(51) Int. Cl. G06Q 30/02

(52) U.S. Cl. 705/14.45; 705/14.41

(57) ABSTRACT

Methods, systems, and apparatuses, including computer programs encoded on computer-readable media, for receiving an image of a product. Searching web content using a search query based on the image of the product. Receiving search results including a plurality of uniform resource locators (URL) based on the web content search using the image of the product. Identifying one or more advertising campaigns comprise at least one advertisement that includes a URL in the plurality of URLs. Obtaining one or more keywords associated with the one or more advertising campaigns. Determining a list of suggested keywords for the product based on the obtained one or more keywords. Providing the list of suggested keywords.

### BACKGROUND

Advertisements supplement various content available on the internet. Some of the advertisements embedded in content are targeted to users based upon data provided by a user. Keywords input into a search engine is one way an advertisement can be targeted to a user. Advertisers can bid on the ability to place an advertisement when a user searches content using a particular keyword or keywords. Campaigns can include advertisements that can be displayed when a user types in various keywords. The advertisement can be associated with a large number of keywords. Determining which keywords to use in a particular campaign can be a lengthy and daunting process.

### SUMMARY

In general, one aspect of the subject matter described in this specification can be embodied in methods for receiving an image of a product. Searching web content using a search query based on the image of the product. Receiving search results including a plurality of uniform resource locators (URL) based on the web content search using the image of the product. Identifying one or more advertising campaigns comprise at least one advertisement that includes a URL in the plurality of URLs. Obtaining one or more keywords associated with the one or more advertising campaigns. Determining a list of suggested keywords for the product based on the obtained one or more keywords. Providing the list of suggested keywords. Other implementations of this aspect include corresponding systems, apparatuses, and computer-readable media configured to perform the actions of the method.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates a block diagram of an advertising keyword-generating system that uses an image search in accordance with an illustrative implementation.

FIG. 2 illustrates an exemplary user interface for providing an initial image in accordance with an illustrative implementation.

FIG. 3 illustrates an exemplary user interface suggesting advertising keywords based upon a provided image in accordance with an illustrative implementation.

FIG. 4 illustrates an exemplary user interface suggesting sites and types of advertisements based upon a provided image in accordance with an illustrative implementation.

FIG. 5 is a flow diagram of a process for generating a list of suggested advertising keywords in accordance with an illustrative implementation.

FIG. 6 is a block diagram of a computer system in accordance with an illustrative implementation.

Like reference numbers and designations in the various drawings indicate like elements.

### DETAILED DESCRIPTION

Advertising campaigns can be created to advertise products and/or services online. An advertising campaign can be directed to a broad product class, such as shoes. A shoe advertising campaign can include multiple advertisements related to shoes. Advertisements can be inserted into search results, web pages, mobile web pages, mobile content, games, online content, etc. Keywords entered into a search engine can be used to generate search results and to determine what advertisements should be inserted into the search results. An advertiser can manually enter one or more keywords used to insert an advertisement into content.

A campaign can include a number of advertisements. Advertisements directed to a similar product or service can be grouped into ad groups. For example, a campaign regarding shoes can include ad groups containing ads directed to ladies shoes, basketball shoes, sports shoes, etc. Advertisements within an ad group can share keywords and other advertising parameters such as, but not limited to, content types that can include the advertisements, specific websites to exclude from placements, reporting data, etc.

Creating advertising campaigns can include selecting a number of a keywords associated with one or more advertisements of the campaign. To expedite the creation of the list of keywords, keywords can be suggested to an advertiser. Suggested keywords can be based upon providing a keyword. The provided keyword is used to search for related keywords. One or more related keywords can be selected to associate the selected keywords to advertisements in a campaign and/or ad group.

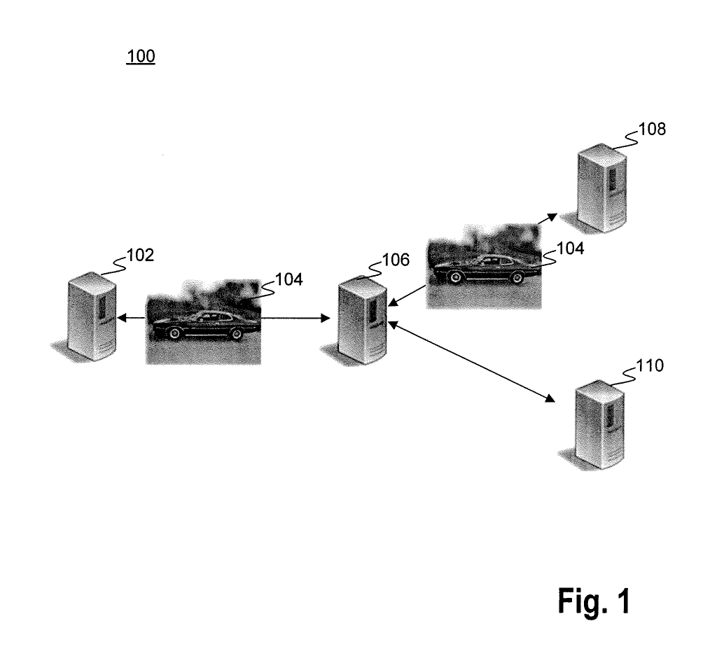

Another way to suggest keywords to an advertiser is based on an image of a product that is to be advertised. In this implementation, the advertiser does not have to provide any initial keywords. Rather, the advertiser supplies an image of the product and the image is used to suggest keywords. FIG. 1 illustrates a block diagram of an advertising keyword-generating system that uses an image search in accordance with an illustrative implementation. A client device 102 can submit an image 104 to a keyword-suggesting device 106. The keyword-suggesting device can submit the image 104 to an image search engine 108. In one implementation, the image search is based only on the image 104. In another implementation, the image search includes the image 104 and text provided by the advertiser. For example, the advertiser can provide a textual description of the product shown in the image 104 and submit the textual description along with the image 104 to the keyword-suggesting device 106.

Using the image 104, the image search engine 108 searches for content that includes images that are similar to the provided image 104. The search results can include information regarding the returned content. For example, the search results can include uniform resource locators (URLs) of content that includes an image similar to the provided image 104. The keyword-suggesting device 106 can determine if any of the content is associated with an advertising account. In one implementation, URLs in the search results are provided to an advertising device 110. The advertising device 110 can determine if any advertising accounts include advertisements that include any of the URLs in the search results. For example, if an account has an advertisement that directs users to a URL in the search results, the keywords associated with the advertisement can be retrieved. In another implementation, the keywords associated with the ad group that includes the advertisement is returned. In yet another implementation, the keywords associated with the campaign that includes the advertisement can be returned. These keywords can be provided to the keyword-suggesting device 106.

In addition to the keywords, data related to each of the keywords can also be received from the advertising device 110. For example, the number of impressions generated from each keyword, a click through rate for each keyword, etc. In addition to data related to keywords, data related to ad groups and/or campaigns that include matched advertisements can be returned. For example, web sites that displayed advertisements, types of advertisements, etc. from an ad group and/or campaign can be returned. The data can be aggregated based upon keywords across the matching advertising campaigns. In another implementation, once a suggested list of keywords is identified, data regarding the keywords across all advertising campaigns can be determined. For example, the number of impressions of a particular keyword across all advertising campaigns can be determined. The keywords and associated data sent to the keyword-suggesting device 106 is anonymous. That is, the returned data does not include data that identifies the owner of any of the matching accounts, campaigns, ad groups, etc.

Using some or all of the keyword and related data, the keyword-suggesting device 106 can determine a list of suggested keywords. For example, the keyword-suggesting device 106 can determine the keywords with the largest number of impressions across all of the matching advertising campaigns. The suggested keywords can include a set of ten, twenty, fifty, etc., keywords that had the largest number of impressions. The suggested keywords can also include a set of keywords based upon the keywords with the highest click-through rate. The keywords can be ordered or ranked based upon this data. Once determined, the set of suggested keywords can be provided to the client device 102. In addition to the suggested keywords, data related to the matching ad groups/campaigns can be provided. For example, an aggregated number of impressions per keyword can be provided along with each of the suggested keywords. After receiving the suggested keywords, the client device 102 can request that an advertisement be displayed based on one or more of the suggested keywords. The advertisement can then be inserted into search results based upon search keywords that match one or more of the selected suggested keywords.

The keyword-suggesting device 106 can also filter out certain keywords. For example, any adult-themed keywords can be removed from the suggested keywords prior to being provided to the client device 102. In another example, keywords that are currently active in an advertiser's campaign, ad group, etc., can be removed from the suggested keyword list. The keyword-suggesting device 106 can also calculate a quality score or request a quality score from the advertising device 110. A quality score generally depends on the relevancy of a keyword. Keywords that are below a particular quality score can be removed from the suggested keyword list. For example, a quality score can take into account the number of impressions, cost for displaying an advertisement based upon the keyword, a click-through rate of the keyword, etc.

Advertisements can also be grouped into an ad group. The ad group can use a single of set of keywords to place advertisements within the ad group. Ad groups are identified by a name. The keyword-suggesting device 106 can also provide examples of names of ad groups. In one implementation, the ad group names are based upon ad groups that the suggested keywords were located. In another implementation, the ad groups can be based upon the suggested keywords themselves. For example, a keyword of “used black muscle car” can be used to generate suggested ad group names of “muscle cars,” “black cars,” “used cars,” etc.

The suggested items returned by the keyword-suggesting device 106 can be turned on/off by the user. For example, a user can turn off ad type suggestions, ad group name suggestions, etc., before submitting an image. In this example, after submitting an image, the user would receive suggested keywords but not suggested ad types or ad group name suggestions.

In the illustrated system 100, the keyword-suggesting device 106, the image search engine 108, and the advertising device 110 are separate computing devices. In other implementations one or more of the computing devices can be combined. For example, the keyword-suggesting device 106 and the advertising device 110 can be a single computing device. In other implementations, multiple computing devices can provide the features of an illustrated device. For example, there can be a number of image search engines 108 that provide search results based upon an image.

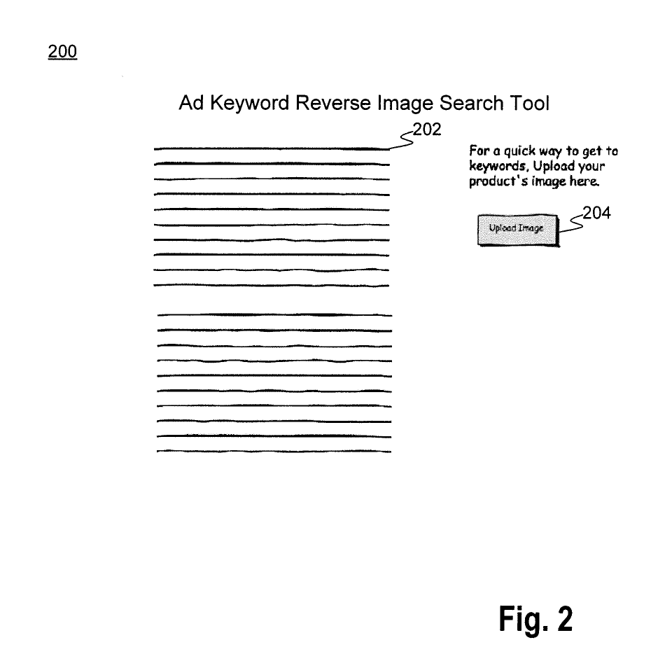

FIG. 2 illustrates an exemplary user interface for providing an initial image in accordance with an illustrative implementation. For example, the user interface 200 can be displayed on a web browser running on the client device 102. An upload image button 204 allows an image to be selected for uploading to the keyword-suggesting device 106. In one implementation, a file selector can be used to locate an image to upload. A text area 202 can allow entry or display of textual data related to the image. In one implementation, the text area 202 can include text that describes the image. In one implementation, the text area 202 allows the entry of text. For example, the text can identify the product in the image 104 and provide a brief description of the product, the product's market, target customers, etc. In another implementation, the text area 202 can include data from a web page that is associated with the product in the image 104 and describes the product. Once an image is selected, the image can be uploaded to the keyword-suggesting device 106.

Using the received image, the keyword-suggesting device 106 can determine a suggested list of keywords. As described above, the image 104 can be used to initiate a search of content, such as, but not limited to, content available on the internet, to find content that includes images related to the received image 104. In one implementation, the suggested keywords are based upon keywords from advertising campaigns that include a URL that is returned in the search results. In another implementation, one or more of the suggested keywords are used as search keywords to a search engine. The search results can include organic search results and advertisements that were selected based upon the keywords. The URLs from the organic search results can be used to find matching advertising campaigns similar to advertising campaigns based upon the image search results. The advertisements, however, are identified as a matching campaign by being returned based upon the keyword search. The selection and return of an advertisement in this case, however, is not considered an impression and does not incur any cost or data related to the campaign from which the advertisement was selected. Once the matching advertisement campaigns/ad groups are identified, a second set of suggested keywords and data can be obtained in a similar manner as the suggested keywords and data from the image search. In one implementation, each keyword is used in a separate search. The suggested list of keywords based upon the image search can be supplemented with keywords from the matched advertising campaigns/ad groups from the search results. In addition, the data related to the keywords and/or advertising campaigns/ad groups from both the image search and the one or more web searches can be combined.

In one implementation, matching advertising campaigns are determined. All keywords associated with the matching campaign are returned to the keyword-suggesting device 106. A campaign can include one or more ad groups. Each ad group can have its own set of keywords that can differ from the keywords of other ad groups. In one implementation, matching ad groups are determined, instead of matching campaigns. The keywords from the matching ad groups are returned to the keyword-suggesting device 106.

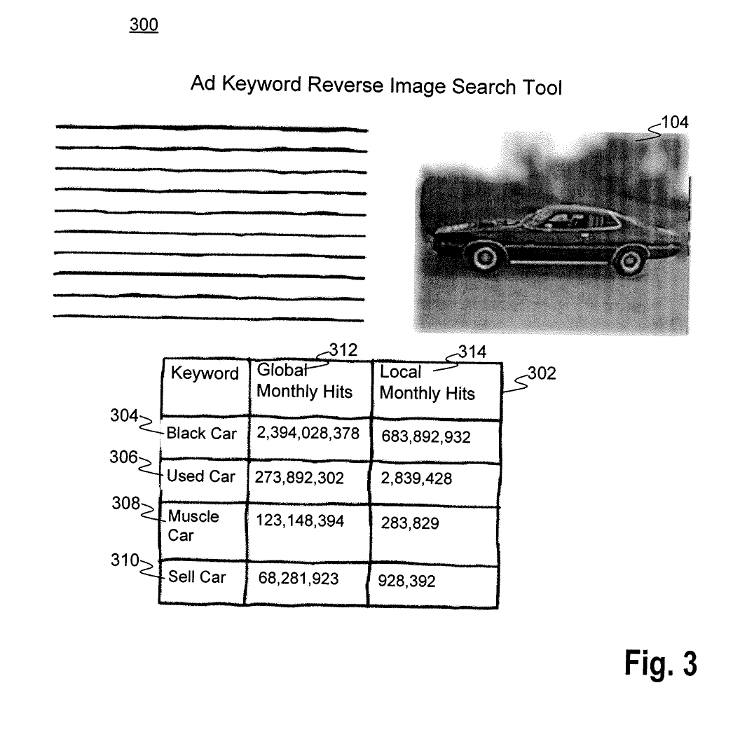

Once the set of suggested keywords are determined, they can be sent to the client device 102 and provided to a user. FIG. 3 illustrates an exemplary user interface suggesting advertising keywords based upon a provided image in accordance with an illustrative implementation. The user interface 300 can include a copy of the image 104 that was previously uploaded and used to search for related content. The suggested keywords 304, 306, 308, and 310 can be listed in a table 302. In addition to the suggested keywords, the table 302 can include aggregated data such as, but not limited to, the number of times a suggested keyword was used as a search keyword in all searches 312 and/or searches from a geographic area 314. Other data, such as click-through rate, a number of times a keyword was clicked, an average cost per click, cost per view, etc. can be provided to the client device 102. Any of the keywords 304, 306, 308, or 310 can selected, for example, through a checkbox or link.

In one implementation, an advertising campaign or ad group can be selected and provided along with the image 104 to the keyword-suggesting device 106. For example, an advertiser can create or select an advertising campaign or ad group and request suggested keywords based upon image 104. After one or more suggested keywords are selected, the selected advertising campaign or ad group can be updated to be associated with the selected keywords. For example, suggested keywords 306 and 308 can be selected from user interface 300. An advertising campaign or ad group associated with the product in image 104 can be updated with the selected suggested keywords 306 and 308. The advertisements that are part of the selected advertising campaign or ad group can then be inserted into various content based upon the suggested keywords 306 and 308. For example, search results from a search using the keywords “used car” can include an advertisement selected from the selected advertising campaign or ad group.

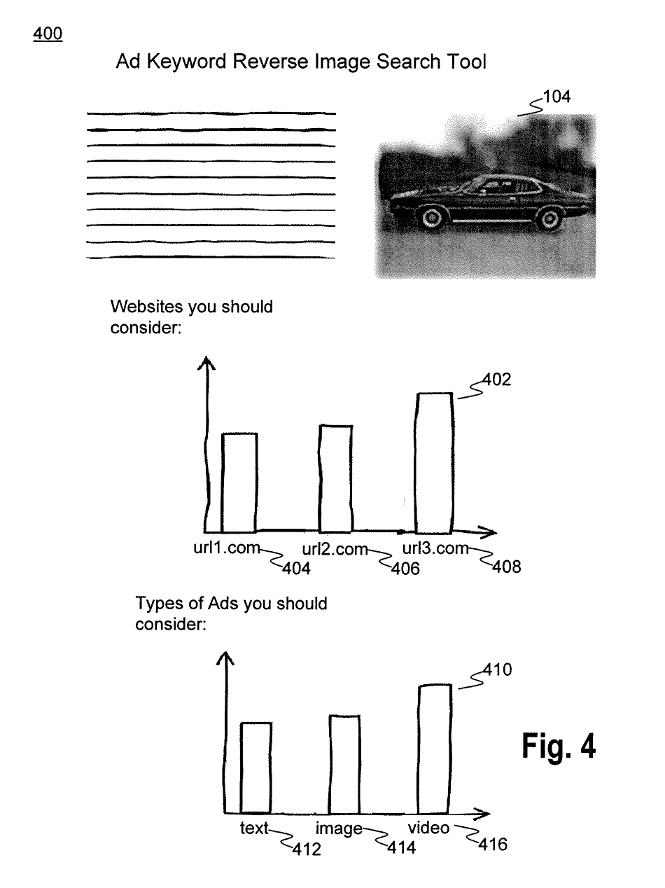

In addition to providing suggested keywords, other suggestions for an advertising campaign or ad group can be provided. FIG. 4 illustrates an exemplary user interface suggesting sites and types of advertisements based upon a provided image in accordance with an illustrative implementation. The user interface 400 includes a chart 402 that illustrates the number of campaigns that place ads on three different sites 404, 406, and 408. In addition to sites, the interface 400 can include a chart 410 that illustrates the number of advertising campaigns that include particular types of advertisements. An advertiser can create different types of advertisements, such as text 412, image 414, video 416, mobile (not shown), etc. User interface 400 can also include the number of matching advertising campaigns that are used to generate any data. User interface 400 can also include the data in forms other than tables, for example, in tabular format.

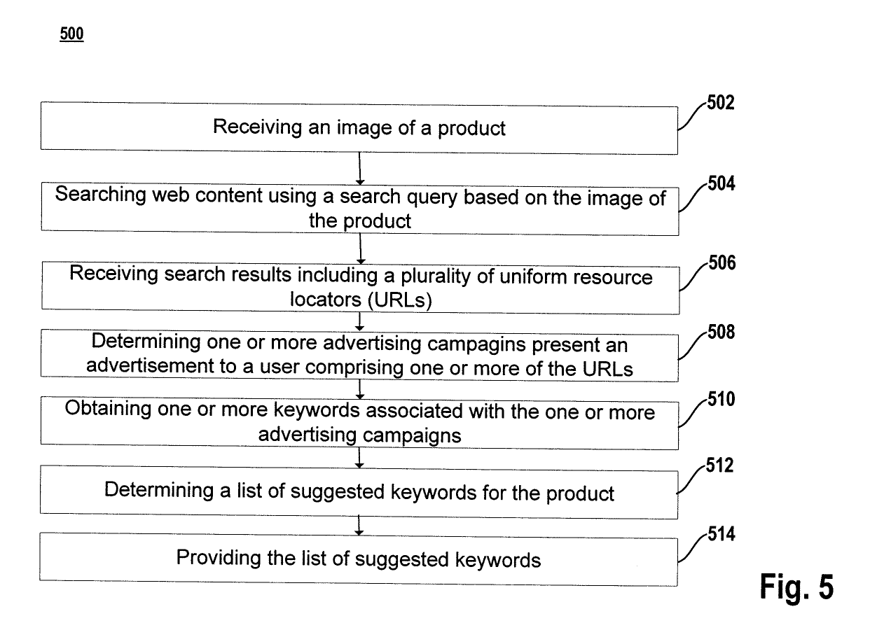

FIG. 5 is a flow diagram of a process for generating a list of suggested advertising keywords in accordance with an illustrative implementation. The process 500 can be implemented on a computing device. In one implementation, the process 500 is encoded on a computer-readable medium that contains instructions that, when executed by a computing device, cause the computing device to perform operations of the process 500.

The process 500 includes receiving an image of a product (502). The image of the product is used to search web content (504). In one implementation, a search query based on the image of the product is used to search web content. In another implementation, the search query is based on the image of the product and a textual description of the product. Search results from the web content search is received (506). The search results include a number of URLs. Advertising campaigns or ad groups that include advertisements that include a URL present in the search results are considered matching advertising campaigns. The keywords from the matching advertising campaigns are obtained (510). A suggested list of keywords is determined from the keywords from the matching advertising campaigns (512). In one implementation, data associated with the keywords is received. Data associated with keywords can include, but is not limited to, the click-through rate of the keywords in the matching advertising campaigns, the click through rate of the keywords from all advertising campaigns, etc. The keywords are ranked based upon the data associated with the advertising campaigns. For example, the keywords can be sorted in descending order based upon the click-through rate of the keywords from all advertising campaigns. The suggested list of keywords can include the first ten, twenty-five, fifty, etc., keywords. Once determined, the suggested keywords can be provided (514). For example, the suggested keywords can be provided to an advertiser through the client device 102.

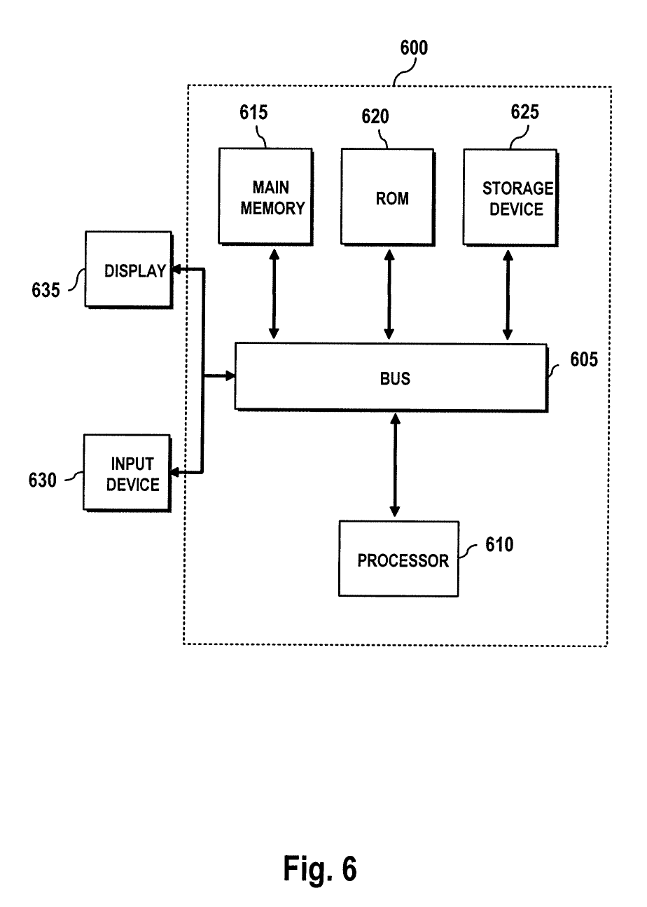

FIG. 6 is a block diagram of a computer system in accordance with an illustrative implementation. The computer system or computing device 600 can be used to implement the client device 102, the keyword-suggesting device 106, the image search engine 108, etc. The computing system 600 includes a bus 605 or other communication component for communicating information and a processor 610 or processing circuit coupled to the bus 605 for processing information. The computing system 600 can also include one or more processors 610 or processing circuits coupled to the bus for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 610 or other static storage device coupled to the bus 605 for storing static information and instructions for the processor 610. A storage device 625, such as a solid state device, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information and command selections to the processor 610. In another implementation, the input device 630 has a touch screen display 635. The input device 630 can include a cursor control, such as a mouse, a trackball, or cursor direction keys, for communicating direction information and command selections to the processor 610 and for controlling cursor movement on the display 635.

According to various implementations, the processes described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

Although an example computing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special-purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving an image of a product;
searching, using a processing circuit, web content using a search query based on the image of the product;
receiving search results comprising a plurality of uniform resource locators (URL) based on the web content search using the image of the product;
identifying one or more advertising campaigns that comprise at least one advertisement that includes a URL in the plurality of URLs;
obtaining one or more keywords associated with the one or more advertising campaigns;
determining a list of suggested keywords for the product based on the obtained one or more keywords; and
providing the list of suggested keywords.

2. The method of claim 1, further comprising:
receiving a selection of one or more suggested keywords; and
placing an advertisement for the product based in part on the selected one or more keywords.

3. The method of claim 1, further comprising obtaining a number of impressions per keyword, a click-through rate per keyword, websites that displayed an advertisement and types of advertisement used from each of the one or more advertising campaigns.

4. The method of claim 3, further comprising aggregating the impressions per keyword, the click-through rate per keyword, websites that displayed an advertisement, and the types of advertisements used across the one or more advertising campaigns.

5. The method of claim 4, further comprising providing the aggregated impressions per keyword, the aggregated click-through rate per keyword, the aggregated websites that displayed an advertisement, and the aggregated types of advertisements used across the one or more advertising campaigns.

6. The method of claim 4, further comprising ranking the suggested list of keywords based in part upon one or more of the aggregated impressions per keyword, the aggregated click-through rate per keyword, the aggregated websites that displayed an advertisement, and the aggregated types of advertisements used across the one or more advertising campaigns.

7. The method of claim 1, further comprising receiving a text search term, wherein searching web content further comprises using the text search term.

8. The method of claim 7, wherein the text search term identifies the product.

9. The method of claim 1, further comprising:
receiving a language and a geographic region related to advertising of the product; and
determining a language and a geographic region of the one or more advertising campaigns that match the received language and the received geographic region.

10. The method of claim 1, wherein determining a list of suggested keywords comprises:
searching web content using the obtained one or more keywords as search terms;
receiving a second set of search results comprising a plurality of uniform resource locators (URL) based on the web content search using the obtained one or more keywords;
identifying a second set of one or more advertising campaigns, wherein each of the one of more advertising campaigns in the second set comprises an advertisement that includes a URL in the second set of search results;
obtaining a second set of one or more keywords used in the second set of one or more advertising campaigns;
determining the list of suggested keywords for the product based on the obtained one or more keywords and the obtained second set of one or more keywords.

11. A system comprising:
one or more processing circuits configured to:
receive an image of a product;
search web content using a search query based on the image of the product;
receive search results comprising a plurality of uniform resource locators (URL) based on the web content search using the image of the product;
identify one or more advertising campaigns that comprise at least one advertisement that includes a URL in the plurality of URLs;
obtain one or more keywords associated with the one or more advertising campaigns;
determine a list of suggested keywords for the product based on the obtained one or more keywords; and
provide the list of suggested keywords.

12. The system of claim 11, wherein the one or more processing circuits are further configured to:
receive a selection of one or more suggested keywords; and
place an advertisement for the product based in part on the selected one or more keywords.

13. The system of claim 11, wherein the one or more processing circuits are further configured to receive a text search term, wherein searching web content further comprises using the text search term.

14. The system of claim 11, wherein the one or more processing circuits are further configured to:
receive a language and a geographic region related to advertising of the product; and
determine a language and a geographic region of the one or more advertising campaigns that match the received language and the received geographic region.

15. The system of claim 11, wherein the one or more processing circuits are further configured to:
search web content using the obtained one or more keywords as search terms;
receive a second set of search results comprising a plurality of uniform resource locators (URL) based on the web content search using the obtained one or more keywords;
identify a second set of one or more advertising campaigns, wherein each of the one of more advertising campaigns in the second set comprises an advertisement that includes a URL in the second set of search results;
obtain a second set of one or more keywords used in the second set of one or more advertising campaigns;
determine the list of suggested keywords for the product based on the obtained one or more keywords and the obtained second set of one or more keywords.

16. A non-transitory computer-readable medium having instructions stored thereon, the instructions comprising:
instructions to receive an image of a product;
instructions to search web content using a search query based on the image of the product;
instructions to receive search results comprising a plurality of uniform resource locators (URL) based on the web content search using the image of the product;
instructions to identify one or more advertising campaigns that comprise at least one advertisement that includes a URL in the plurality of URLs;
instructions to obtain one or more keywords associated with the one or more advertising campaigns;
instructions to determine a list of suggested keywords for the product based on the obtained one or more keywords; and
instructions to provide the list of suggested keywords.

17. The non-transitory computer-readable medium of claim 16, further comprising:
instructions to receive a selection of one or more suggested keywords; and
instructions to place an advertisement for the product based in part on the selected one or more keywords.

18. The non-transitory computer-readable medium of claim 16, further comprising instructions to receive a text search term, wherein searching web content further comprises using the text search term.

19. The non-transitory computer-readable medium of claim 16, further comprising:
instructions to receive a language and a geographic region related to advertising of the product; and
instructions to determine a language and a geographic region of the one or more advertising campaigns that match the received language and the received geographic region.

20. The non-transitory computer-readable medium of claim 16, further comprising:
instructions to search web content using the obtained one or more keywords as search terms;
instructions to receive a second set of search results comprising a plurality of uniform resource locators (URL) based on the web content search using the obtained one or more keywords;
instructions to identify a second set of one or more advertising campaigns, wherein each of the one of more advertising campaigns in the second set comprises an advertisement that includes a URL in the second set of search results;
instructions to obtain a second set of one or more keywords used in the second set of one or more advertising campaigns;
instructions to determine the list of suggested keywords for the product based on the obtained one or more keywords and the obtained second set of one or more keywords.
